(19) United States
(12) Patent Application Publication
(10) Pub. No.: US 2006/0138839 A1
(43) Pub. Date: Jun. 29, 2006

(54) Flip and slide seat assembly

(76) Inventors: Christopher J. Ryan, Fraser, MI (US); Srinivas Pejathaya, St. Clair Shores, MI (US)

Correspondence Address: HARNESS, DICKEY & PIERCE, P.L.C., P.O. BOX 828, BLOOMFIELD HILLS, MI, 48303, US

(21) Appl. No.: 11/001,653

(22) Filed: Dec. 1, 2004

(51) Int. Cl. B60N 2/02

(52) U.S. Cl. 297/340

(57) ABSTRACT

A vehicle seat recliner assembly is provided. The assembly generally includes a base, a drive link, a support bracket and a carrier link. The drive link is supported on the base for pivotal displacement between a first position and a second position. The support bracket is located rearward of the base. The carrier link has a first end pivotally attached to the drive link and a second end pivotally attached to the support bracket. The carrier link is adapted to forwardly displace the support bracket from a first position to a second position in response to the drive link pivoting from its first position to its second position.

### FIELD OF THE INVENTION

The present invention relates to a vehicle seat recliner assembly and, more particularly, to a flip and slide seat frame assembly providing for ingress/egress to the area behind the vehicle seat for cargo, as well as third row access.

### BACKGROUND OF THE INVENTION

Minivan and sport utility markets are extremely competitive. A growing focus of the competition is the overall utility and comfort of these vehicles. One important utility feature that is gaining much attention includes flexible vehicle interiors and, more particularly, flexible second row seating assemblies. Flexibility, in this sense, refers to the ability to modify the configuration of a particular seating assembly. For example, when a passenger wants to access third row, this feature provides more ingress/egress room. Additionally the passenger might desire to fold down a front or second row seat to provide for a workspace during travel. As such, the passenger could use the rear of the seat back as a table top. This feature also allows for more cargo space.

### SUMMARY OF THE INVENTION

A vehicle seat recliner assembly is provided. The assembly generally includes a base, a drive link, a support bracket, and a carrier link. The drive link is supported on the base for pivotal displacement between a first position and a second position. The support bracket is located directly behind of the base. The carrier link has a first end pivotally attached to the drive link and a second end pivotally attached to the support bracket. The carrier link is adapted to forwardly displace the support bracket from a first position to a second position in response to the drive link pivoting from its first position to its second position.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a vehicle seat recliner assembly in accordance with the present invention in an operating position;

FIG. 2 is an exterior side view of a first lateral subassembly of the vehicle seat recliner assembly of FIG. 1 in an operating position;

FIG. 3 is an exploded view of the first lateral subassembly of FIG. 2;

FIG. 4 is an exterior side view of a support assembly of the first lateral subassembly of FIG. 1;

FIG. 5 is an interior side view of the support assembly of FIG. 4;

FIG. 6 is an exterior side view of the first lateral subassembly of FIG. 1 in an ingress/egress position;

FIG. 7 is a side view of a vehicle seat assembly in accordance with the present invention in an operating position; and

FIG. 8 is a side view of the vehicle seat assembly of FIG. 7 in an ingress/egress position.

### DETAILED DESCRIPTION OF THE PREFERRED EMBODIMENTS

The following description of the preferred embodiments is merely exemplary in nature and is in no way intended to limit the scope of the present invention, its application, or its uses.

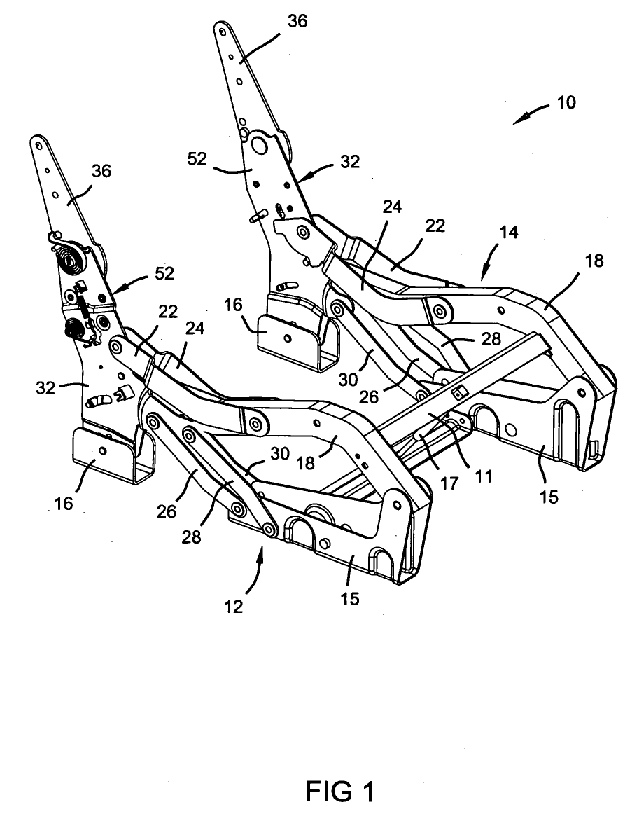

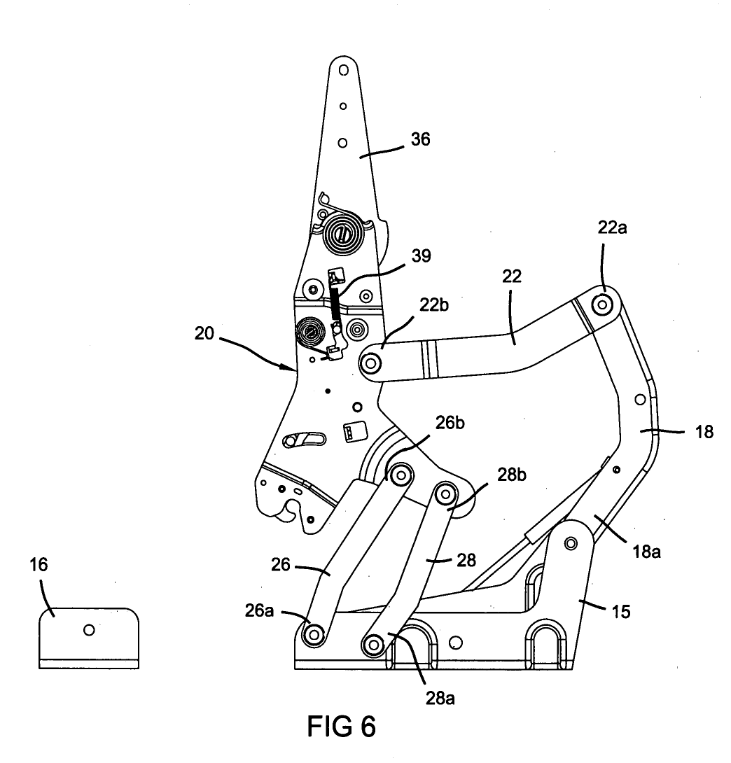

With reference to FIG. 1, a vehicle seat recliner assembly 10 in accordance with the present invention generally includes first and second lateral subassemblies 12, 14 connected by upper and lower cross braces 11, 13. A strut 17 is disposed between the upper and lower cross braces 11, 13 to bias the assembly 10 out of the position illustrated in FIG. 1, which is described herein as the operating position, toward the position illustrated in FIG. 6, which is described herein as the ingress/egress position. It should be appreciated that the lateral assemblies 12, 14 are mirror images of each other and that they include similar elements.

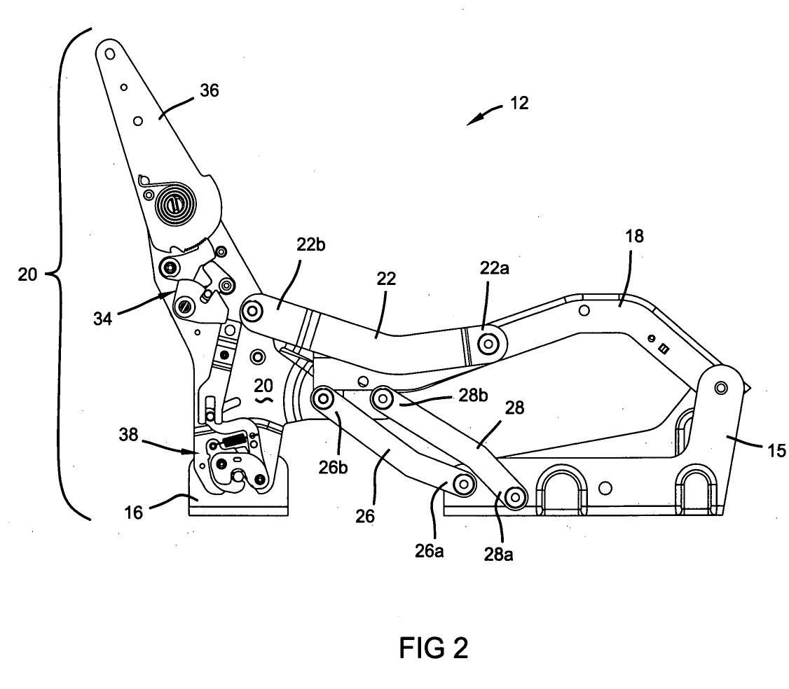

Referring to FIGS. 2-4, the lateral subassemblies 12, 14 are described, with specific reference to the first lateral subassembly 12. The first lateral subassembly 12 generally includes a base 15, a striker plate 16, a drive member 18, a support assembly 20, and a linkage assembly 25. The base 15 is a U-shaped metal bracket that is adapted to be attached to a vehicle floor. The striker plate 16 is a U-shaped metal bracket that is adapted to be attached to a vehicle floor. The striker plate 16 is located directly behind of the base 15 and includes a striker pin 19. The drive member 18 is a metal channel having a generally upside down U-shaped cross section including a first end 18a pivotally attached to the base 15.

The support assembly 20 generally includes an exterior support bracket 32, an interior support bracket 52, a recliner mechanism 34, and a striker pin latch mechanism 38. The recliner mechanism 34 is rotatably supported between the first and second support brackets 32, 52.

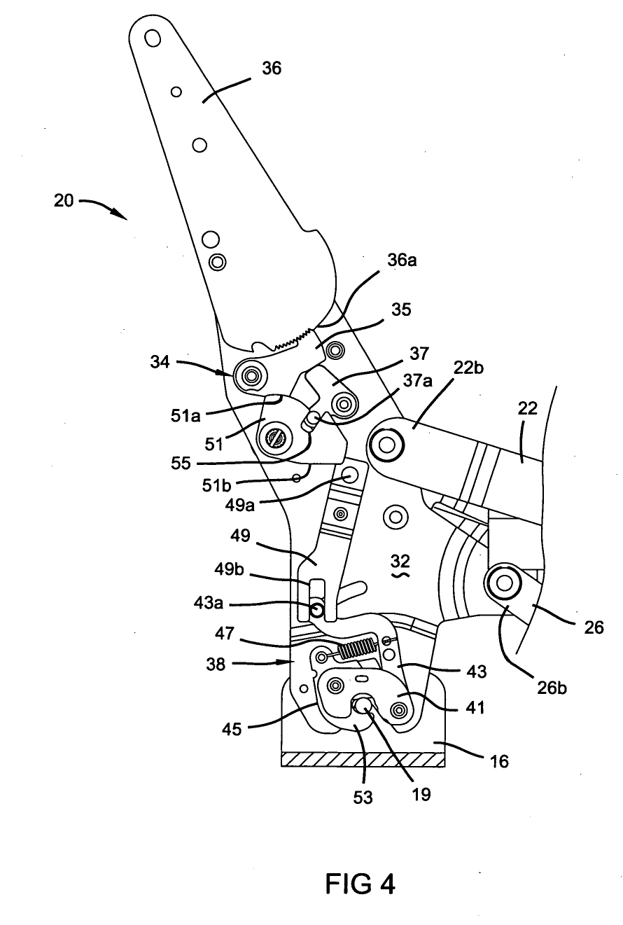

With specific reference to FIG. 4, the recliner mechanism 34 includes a recliner arm 36, a pawl 35, a release cam 37, a biasing member 39, and an interlocking cam 51. The recliner arm 36 is supported for pivotal displacement on the support bracket 32 and includes an arcuate edge 36a having a plurality of teeth. The pawl 35 is also supported for pivotal displacement on the support bracket 32 and includes a plurality of teeth adapted to lockingly engage the plurality of teeth on the recliner arm 36. The release cam 37 is supported for pivotal displacement on the support bracket 32 and engages the pawl 35, thereby locking the teeth on the pawl 35 into engagement with the teeth on the recliner arm 36. The biasing member 39 includes a coil spring disposed between the recliner arm 36 and the release cam 37 to bias the release cam 37 into engagement with the pawl 35 to lock the recliner mechanism 34. The interlocking cam 51 is disposed between the release cam 37 and the pawl 35, and is adapted to prevent the recliner mechanism 34 from disengaging under certain conditions, as will be described in more detail in correlation with the striker pin latch mechanism 38.

With continued reference to FIG. 4, the striker pin latch mechanism 38 is attached to the support bracket 32 and adapted to lock the support assembly 20 to the striker pin 19 on the striker plate 16. The striker pin latch mechanism 38 includes a housing plate 41, a release lever 43, a lock claw 45, a biasing member 47, and an interlocking lever 49. The housing plate 41 is mounted to the support bracket 32. The release lever 43 is supported on the support bracket 32 for pivotal displacement between a latched position (shown in FIG. 4) and an unlatched position (not shown). The lock claw 45 is supported for rotational displacement on the support bracket 32 and includes a claw portion 53 adapted to engage the striker pin 19 when the release lever 43 is in the latched position. The biasing member 47 is disposed between the lock claw 45 and the release lever 43 and is adapted to bias the lock claw 45 into locking engagement with the striker pin 19. The interlocking lever 49 is disposed between the release lever 43 and the interlocking cam 51 of the recliner mechanism 34 and is supported for rotational displacement on the support bracket 32.

The interlocking lever 49 includes a first end having a boss 49a for selectively engaging the interlocking cam 51 and a second end having a slot 49b engaging a boss 43a formed on the release lever 43. The interlocking cam 51 is disposed between the release cam 37 and pawl of the recliner mechanism 34. The interlocking cam 51 includes an arcuate edge 51a, a slot 55, and a locking surface 51b. The arcuate edge 51a engages the pawl 35 and the slot 55 engages a boss 37a formed on the release cam 37. The locking surface 51b is adapted to be engaged by the boss 49a on the interlocking lever 49 when the striker pin latch mechanism 38 is disengaged. The above-described configuration provides a feature that prevents the recliner mechanism 34 from being disengaged when the striker pin latch mechanism 38 is disengaged from the striker plate 16, thereby preventing multiple simultaneous operations and confusion to the consumer.

To disengage the striker pin latch mechanism 38 from the striker pin 19, the release lever 43 is pivoted in a clockwise direction. This rotates the lock claw 45 out of locking engagement with the striker pin 19. The interlocking lever 49 rotates counter-clockwise such that the boss 49 formed thereon engages the lock surface 51b on the interlocking cam 51. Thus, the arcuate edge 51a engages the pawl 35 and prevents the pawl 35 from disengaging the recliner arm 36. The interlocking lever 49 and interlocking cam 51, in effect, act as a column between the pawl 35 and boss 43a formed on the release lever 43.

With reference to FIGS. 2, 3, and 5, the linkage assembly 25 includes first and second carrier links 22, 24, first and second external vault links 26, 28, and an internal vault link 30. The first and second carrier links 22, 24 each include first ends 22a, 24a pivotally attached to the drive member 18 and second ends 22b, 24b pivotally attached to the support bracket 32. In an exemplary embodiment, the carrier links 22, 24 resemble bell cranks.

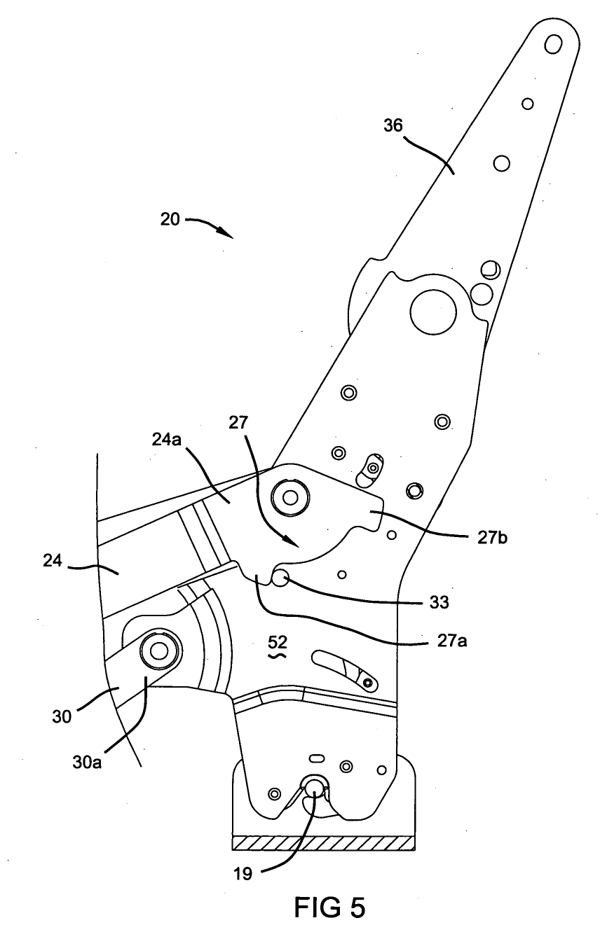

Referring specifically to FIG. 5, the second carrier link 24 further includes a hip flange 27 formed on its second end 24b. The hip flange 27 includes a first shoulder 27a and a second shoulder 27b. The first shoulder engages a boss 33 formed on the interior support bracket 52 when the assembly 10 is in the operating position (shown in FIG. 5). The second shoulder 27b is adapted to engage the boss 33 when the second carrier link 24 pivots about the support assembly 20 to the ingress/egress position (shown in FIG. 6). In each position, the respective shoulders 27a or 27b act as a stop by engaging the boss 33, thereby preventing over-rotation of the carrier links 22, 24 and the drive member 18.

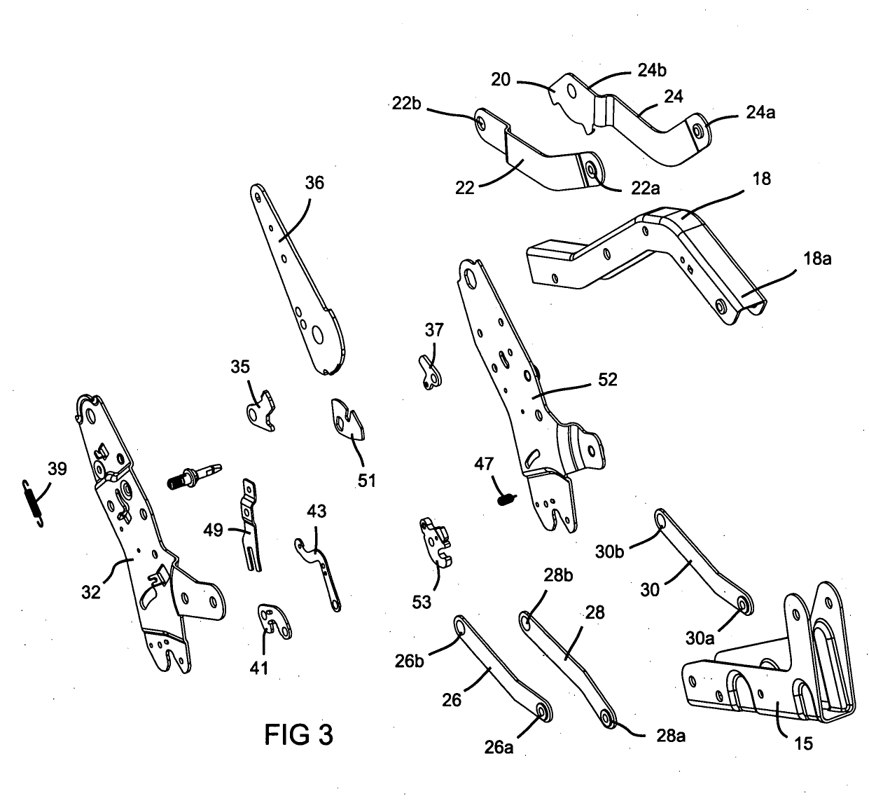

Referring back to FIGS. 2 and 3, the vault links 26, 28, 30 each have first ends 26a, 28a, 30a pivotally attached to the base 15 and second ends 26b, 28b, 30b pivotally attached to the support bracket 32. Furthermore, the vault links 26, 28, 30 each have slightly V-shaped profiles. Lastly, each of the aforesaid pivotal attachments is achieved through the use of a fastener. In an exemplary embodiment, the fastener includes a rivet; however, other types of fasteners are intended to be within the scope of the present invention.

The vehicle seat recliner assembly 10 is manipulable between an operating position, shown in FIG. 1, and an ingress/egress position, shown in FIG. 6. To do so, the striker pin latch mechanism 38 is decoupled from the striker pin 19 in the manner described above. This enables the drive member 18 to pivot in a clockwise direction about its first end 18a from a seating position, shown in FIG. 1, to a loading position, shown in FIG. 6. This causes the carrier links 22, 24 to rotate in a counterclockwise direction about the support assembly 20, thereby disengaging the first shoulder 27a of the hip flange 27 from the boss 33 disposed on the interior support bracket 52. Subsequent to the drive member 18 pivoting a predetermined amount, the second shoulder 27b on the hip flange 27 engages the boss 33 and the carrier links 22, 24 cease rotation. This causes the carrier links 22, 24 to displace forward, pulling the support assembly 20 along. As the support assembly 20 displaces forward, the vault links 26, 28, 30 initially displace the support assembly 20 upward and then downward. Therefore, the combination of carrier 22, 24 and vault 26, 28, 30 links forces the support assembly 20 to move along an arch-shaped travel path from the operating position, shown in FIG. 2, to the ingress/egress position, shown in FIG. 6.

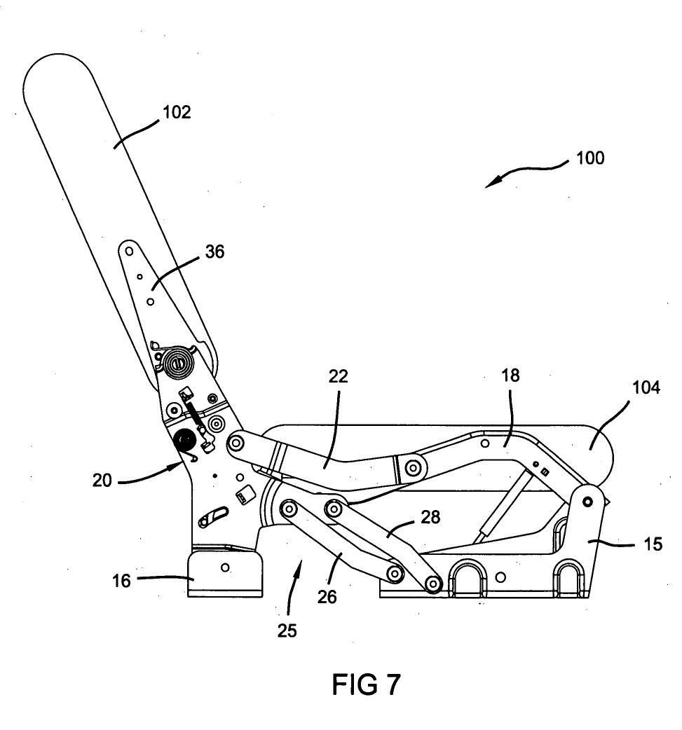

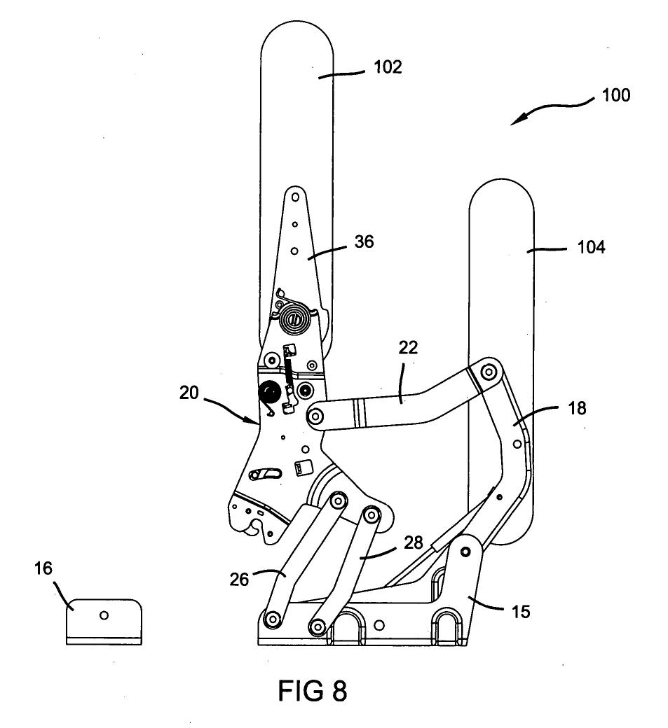

With reference now to FIGS. 7 and 8, a vehicle seat assembly 100 in accordance with the present invention is described. The vehicle seat assembly 100 generally includes a seat back 102, a seat bottom 104, and a vehicle seat recliner assembly 10. The vehicle seat recliner assembly 10 is identical to that described above and includes first and second lateral subassemblies 12, 14 connected by upper and lower cross braces 11, 13. Each of the lateral assemblies 12, 14 include a base 15, a striker plate 16, a drive member 18, a support assembly 20, and a linkage assembly 25. As described above, the support assembly 20 include first and second support brackets 32, 52, a recliner mechanism 34, and a striker pin latch mechanism 38. The seat back 102 is attached between the lateral subassemblies 12, 14 to the recliner arms 36 of the recliner mechanisms 34. The seat bottom 104 is attached between the lateral subassemblies 12, 14 to the drive members 18.

Operation of the vehicle seat assembly 100 mirrors the operation of the vehicle seat recliner assembly 10 described above. The striker pin latch mechanism 38 is decoupled from the striker plate 16. The seat bottom 104 is pivoted in a clockwise direction relative to the base 15. This initially causes the carrier links 22, 24 to rotate in a counterclockwise direction about the support assembly 20, thereby disengaging the first shoulder 27a of the hip flange 27 from the boss 33 formed on the interior support bracket 32. Subsequent to the seat bottom 104 pivoting a predetermined amount, the second shoulder 27b on the hip flange 27 engages the boss 33 and the carrier links 22, 24 cease rotation. This causes the carrier links 22, 24 to displace forward, pulling the seat back 102 along. As the seat back 102 displaces forward, the vault links 26, 28, 30 displace the seat back 102 initially upward and then downward. Therefore, the combination carrier 22, 24 and vault 26, 28, 30 links forces the seat back 102 to move along an arch-shaped travel path from the operating position, shown in FIG. 7, to the ingress/egress position, shown in FIG. 8.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle seat recliner assembly comprising:
a base;
a drive member supported on said base for pivotal displacement between a seating position and a loading position;
a support bracket located in a common plane with said base; and
a carrier link having a first end pivotally attached to said drive member and a second end pivotally attached to said support bracket, said carrier link adapted to forwardly displace said support bracket from a first position to a second position in response to said drive member pivoting from said seating position to said loading position.

2. The assembly of claim 1, further comprising a vault link having a first end pivotally attached to said base and a second end pivotally attached to said support bracket, said vault link operable to provide an arch-shaped travel path for said support bracket between said first and second positions.

3. The assembly of claim 1, wherein said drive member extends substantially rearward from said base when in said seating position.

4. The assembly of claim 1, wherein said drive member is a channel having a generally upside down U-shaped cross-section.

5. The assembly of claim 1, wherein said drive member extends substantially upward from said base when in said loading position.

6. The assembly of claim 1, wherein said support bracket is located a first distance behind said base when in said first position and a second distance behind said base when in said second position and said first distance is greater than said second distance.

7. The assembly of claim 1, wherein said carrier link is a bell crank such that said forward displacement of said support bracket occurs subsequent to said drive member pivoting a predetermined amount from said seating position.

8. The assembly of claim 1 wherein said second end of said carrier link includes a first shoulder adapted to engage a boss formed on said support bracket when said drive member is in said seating position and a second shoulder adapted to engage said boss when said drive member is in said loading position.

9. The assembly of claim 1 further comprising a recliner mechanism rotatably attached to said support bracket.

10. The assembly of claim 9, wherein said recliner mechanism is a rotary disc recliner mechanism.

11. The assembly of claim 1 further comprising a striker pin latch mechanism adapted to lock said support bracket in said first position.

12. A vehicle seat assembly comprising:
a seat back;
a seat bottom;
a base;
a drive member attached to said seat bottom and having an end supported for pivotal displacement on said base, said drive member adapted to pivot said seat bottom between a seating position and a loading position;
a support bracket located in a common plane with said base and attached to said seat back; and
a carrier link having a first end pivotally attached to said drive link and a second end pivotally attached to said support bracket, said carrier link adapted to forwardly displace said seat back from a first position to a second position in response to said seat bottom being pivoted from said seating position to said loading position.

13. The assembly of claim 12, wherein said base is adapted to be attached to a vehicle floor.

14. The assembly of claim 12, further comprising a vault link having a first end pivotally attached to said base and a second end pivotally attached to said support bracket, said vault link adapted to provide an arch-shaped travel path for said seat back between first and second positions.

15. The assembly of claim 12, wherein said drive member is a channel having a generally upside down U-shaped cross section.

16. The assembly of claim 12, wherein said seat bottom is substantially horizontal when in said seating position.

17. The assembly of claim 12, wherein said seat back is substantially vertical when in said first and second positions.

18. The assembly of claim 12, wherein said seat back is located at a first distance rearward of said base when in said first position and a second distance rearward of said base when in said second position and said first distance is greater than said second distance.

19. The assembly of claim 12, wherein said carrier link is a bell crank such that said forward displacement of said seat back occurs subsequent to said seat bottom pivoting a predetermined amount from said seating position.

20. The assembly of claim 12 wherein said second end of said carrier link includes a first shoulder adapted to engage a boss formed on said support bracket when said seat bottom is in said seating position and a second shoulder adapted to engage said boss when said seat bottom is in said loading position.

21. The assembly of claim 12 further comprising a recliner mechanism disposed between said seat back and said support bracket to pivotally displace said seat back relative to said seat bottom.

22. The assembly of claim 21, wherein said recliner mechanism is a rotary disc recliner mechanism.

23. The assembly of claim 11, further comprising a striker pin latch mechanism adapted to lock said seat back in said first position.
